(19) United States
(12) Patent Application Publication
(10) Pub. No.: US 2025/0126452 A1
(43) Pub. Date: Apr. 17, 2025

(54) WIRELESS EMERGENCY ALERT SYSTEMS AND METHODS

(71) Applicant: Oshkosh Corporation, Oshkosh, WI (US)

(72) Inventors: Eric Linsmeier, Larsen, WI (US); David Archer, Hortonville, WI (US)

(73) Assignee: Oshkosh Corporation, Oshkosh, WI (US)

(21) Appl. No.: 18/915,050

(22) Filed: Oct. 14, 2024

Related U.S. Application Data
(60) Provisional application No. 63/544,323, filed on Oct. 16, 2023.

(51) Int. Cl. H04W 4/90; G08B 25/00; G08B 25/10; H04W 4/02; H04W 4/40

(52) U.S. Cl. CPC H04W 4/90; G08B 25/009; G08B 25/10; H04W 4/025; H04W 4/40

(57) ABSTRACT

An alert system includes one or more processing circuits. The one or more processing circuits are configured to acquire alert data regarding at least one of an incident or a response vehicle at or responding to the incident, determine, based on the alert data, a distribution area for an alert, and provide the alert data and the distribution area to a wireless emergency alert system. The wireless emergency alert system is configured to distribute the alert including the alert data to user devices positioned within the distribution area. The wireless emergency alert system is configured to communicate with the user devices without requiring the user devices to download or have access to an application or subscription associated with the wireless emergency alert system.

### CROSS-REFERENCE TO RELATED PATENT APPLICATION

This application claims the benefit of and priority to U.S. Provisional Patent Application No. 63/544,323, filed Oct. 16, 2023, which is incorporated herein by reference in its entirety.

### BACKGROUND

Response vehicles include various features and systems for alerting a person that the response vehicle is responding to an emergency. By way of example, the systems may provide warning lights, warning sirens, or other alert devices to a person. However, such systems are limited to providing alerts within an alert range of the vehicle, thereby preventing a person positioned outside of the alert range from being alerted by the system.

### SUMMARY

One embodiment relates to an alert system. The alert system includes one or more processing circuits. The one or more processing circuits are configured to acquire alert data regarding at least one of an incident or a response vehicle at or responding to the incident, determine, based on the alert data, a distribution area for an alert, and provide the alert data and the distribution area to a wireless emergency alert system. The wireless emergency alert system is configured to distribute the alert including the alert data to user devices positioned within the distribution area. The wireless emergency alert system is configured to communicate with the user devices without requiring the user devices to download or have access to an application or subscription associated with the wireless emergency alert system.

Another embodiment relates to method. The method includes acquiring, from a response vehicle, alert data regarding at least one of an incident or the response vehicle at or responding to the incident, determining, based on the alert data, a first distribution area for a first alert, and providing the alert data and the first distribution area to a wireless emergency alert system. The wireless emergency alert system is configured to distribute the first alert including the alert data to user devices positioned within the first distribution area.

Yet another embodiment relates to an alert system. The alert system includes a vehicle system configured to be positioned on a vehicle and one or more processing circuits. The vehicle system includes a sensor configured to generate sensor data associated with the vehicle. The one or more processing circuits are configured to acquire the sensor data, acquire alert data regarding the vehicle at or responding to an incident, determine, based on the alert data and the sensor data, a distribution area for an alert, and provide the alert data and the distribution area to a wireless emergency alert system. The wireless emergency alert system is configured to distribute the alert including the alert data to user devices positioned within the distribution area.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle including various features described herein, according to an exemplary embodiment.

FIG. 2 is a block diagram of a vehicle system including the vehicle of FIG. 1, according to an exemplary embodiment.

FIG. 3 is a block diagram of an alert system including the vehicle system of FIG. 2, according to an exemplary embodiment.

FIG. 4 is a top view of the vehicle of FIG. 1 at an incident or scene where wireless emergency alerts are provided to several people according to a first distribution area, according to an exemplary embodiment.

FIG. 5 is a top view of the vehicle of FIG. 1 responding to an incident or scene where wireless emergency alerts are provided to several people according to a second distribution area, according to an exemplary embodiment.

FIG. 6 is a top view of the vehicle of FIG. 1 responding to an incident where wireless emergency alerts are provided to several people according to a third distribution area, according to an exemplary embodiment.

FIG. 7 is a top view of the vehicle of FIG. 1 responding to an incident or scene where wireless emergency alerts are provided to several people according to a fourth distribution area, according to an exemplary embodiment.

FIG. 8 is a top view of the vehicle of FIG. 1 at to an incident or scene where wireless emergency alerts are provided to several people according to a fifth distribution area, according to an exemplary embodiment.

FIG. 9 is a top view of the vehicle of FIG. 1 responding to an incident or scene where wireless emergency alerts are provided to several people according to a sixth distribution area, according to an exemplary embodiment.

FIG. 10 is a top view of the vehicle of FIG. 1 responding to an incident or scene where wireless emergency alerts are provided to several people according to a differing distribution areas, according to an exemplary embodiment.

FIG. 11 is a top view of the vehicle of FIG. 1 responding to an incident or scene where differing wireless emergency alerts are provided to several people within differing distribution areas, according to an exemplary embodiment.

FIG. 12 is a top view of differing wireless emergency alerts being provided by an emergency alert system to several people within differing distribution areas, according to an exemplary embodiment.

FIG. 13 is a flow chart of a process for providing multiple alerts and multiple distribution areas using a wireless emergency alert system, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a system includes a response vehicle configured to respond to an incident and one or more processing circuits. The one or more processing circuits are configured to acquire alert data regarding at least one of the incident or the response vehicle at or responding to the incident, determine a distribution area for an alert, and provide the alert data and the distribution area to a wireless emergency alert system. The wireless emergency alert system is configured to distribute the alert including the alert data to user devices positioned within the distribution area. According to an exemplary embodiment, the integration of the system with wireless emergency alert system facilitates providing advanced warning to people (e.g., the general population, citizens, pedestrians, drivers, etc.; in cars, outside, in houses, in buildings, etc.) (a) proximate or approaching the incident, (b) proximate or approaching the response vehicle, and (c) in the path of the response vehicle approaching them without (i) requiring people to download or otherwise have access to a special application or subscription on their user devices and (ii) such that the people can take necessary precautionary measures (e.g., seek shelter, evacuate, move over, slow down, take a detour, etc.).

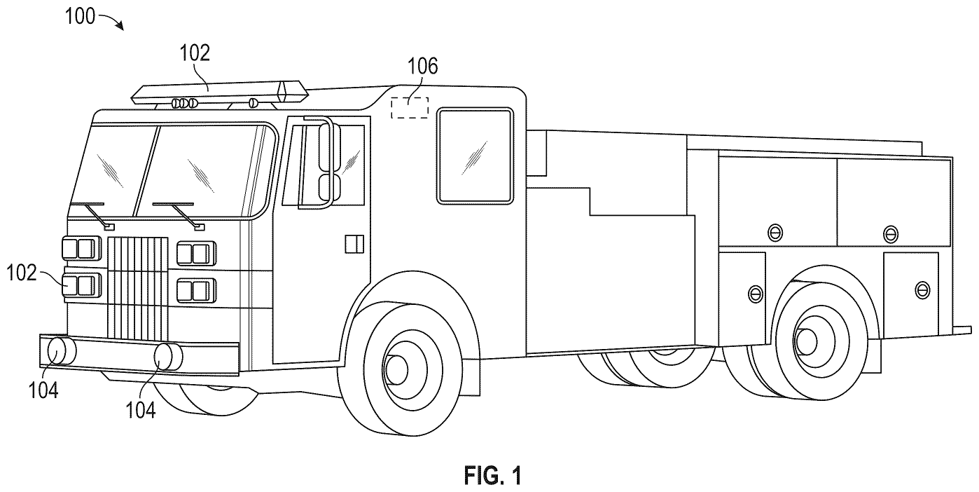

As shown in FIG. 1, a vehicle or machine (e.g., a fire truck, an ambulance, a police car, a tow truck, a construction machine, a refuse truck, etc.), shown as vehicle 100, includes a plurality of visual indicators, shown as emergency lights 102, and one or more audio output devices or audible indicators (e.g., sirens, horns, etc.), shown as speakers 104. The emergency lights 102 may be used to indicate the presence of the vehicle 100 and any surrounding danger. The emergency lights 102 may be located in the front, back, and/or the top of the vehicle 100, or in any other location, to provide the clearest possible view of the emergency lights 102. The speakers 104 may be used to provide an audible warning. The emergency lights 102 and the speakers 104 may include a transmitter, actuation of which provides a visual and an audible alert, respectively.

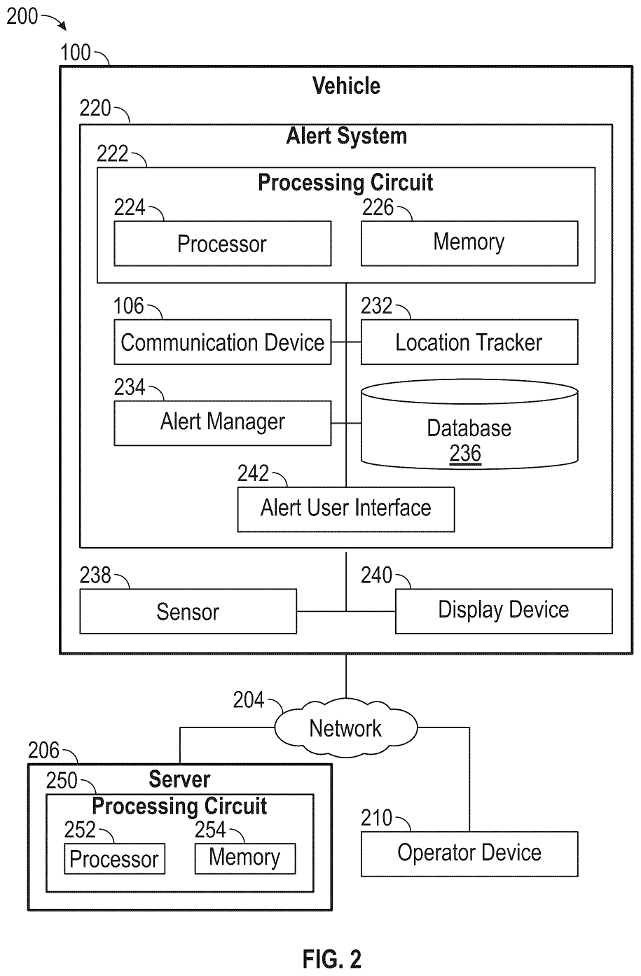

As shown in FIGS. 1 and 2, the vehicle 100 includes an onboard communications device, shown as communication device 106, for transmitting and receiving data via a wireless connection. The communication device 106 may include network communication devices, network interfaces, and/or other possible communication interfaces. The communication device 106 facilitates wireless communication with various external devices and/or other vehicles 100. For example, the communication device 106 may transmit information to a system or person positioned remotely relative to an incident, to a user device of an occupant of a vehicle, or to a commander on site at an incident. The communication device 106 may include wired or wireless communications interfaces (e.g., jacks, antennas, transmitters, receivers, transceivers, wire terminals, etc.) for conducting data communications with sensors, devices, systems, etc., of the vehicle 100 and/or other external systems or devices (e.g., servers, operator devices, etc.). The communication device 106 may be direct (e.g., local wired or wireless communications) and/or via a communications network. For example, the communication device 106 may include an Ethernet card and port for sending and receiving data via an Ethernet-based communications link or network. The communication device 106 may also include a Wi-Fi and/or cellular transceiver for communicating via a wireless communications network. The communication device 106 may include a power line communications interface. The communication device 106 may include an Ethernet interface, a USB interface, a serial communications interface, and/or a parallel communications interface. Further, communication device 106 may facilitate transmissions between multiple response vehicles. In one embodiment, the communication device 106 acts as a repeater, facilitating transmission of signals from another source (e.g., a commander user device, etc.) to a device or response vehicle out of range of the original source.

While the vehicle 100 is shown as a fire truck, it should be understood that the systems and methods disclosed herein are applicable to an ambulance, a police vehicle, a tow truck, a public utility vehicle, a municipal vehicle, a military vehicle, a construction vehicle, a lift device, a refuse truck, a delivery vehicle, a school bus, or any other type of response vehicle or other vehicle that may respond to an incident, be located at a scene (e.g., an accident, a fire, a traffic stop, a construction site or zone, etc.), or make frequent stops (e.g., a refuse vehicle, a delivery vehicle, a school bus, etc.). Further, the systems and methods disclosed herein may be applicable for any type of incident, scene, or site in which providing alerts to members of the public is advantageous (e.g., a train derailment, a chemical spill, a fire, a vehicle collision, a medical event, a crowd event, a traffic jam, a military event, etc.).

### Alert System

FIG. 2 depicts a block diagram of an incident alert system or emergency alert telematics system, shown as communication system 200, according to an exemplary embodiment. The communication system 200 collects, analyzes, and distributes data pertaining to one or more emergency alerts (e.g., emergency notifications, alerts, etc.). Emergency response agencies (e.g., fire and rescue, law enforcement, medical services, military, etc.) may utilize the data and analysis of the communication system 200 to facilitate wirelessly distributing an alert relating to an emergency or incident (e.g., a fire, a building collapse, an earthquake, an active shooter, a hurricane, a flood, a vehicle crash, a snow storm, etc.), to members of the public to better inform the members of the public of the emergency or the incident. The communication system 200 may be associated with or operated by various organizations or agencies that (a) respond to incidents or scenes or (b) that work along public roadways including fire departments, police departments, other emergency response agencies, towing services, construction companies, and the like.

Certain components of the communication system 200 include one or more processors, memory, network interfaces, communication interfaces, and/or user interfaces. Memory may store programming logic that, when executed by the processor, controls the operation of the corresponding computing system or device. Memory may also store data in databases. The network interfaces may allow the systems and/or components of the communication system 200 to communicate wirelessly. The communication interfaces may include wired and/or wireless communication interfaces and the systems and/or components of the communication system 200 may be connected via the communication interfaces. The various components in the communication system 200 may be implemented via hardware (e.g., circuitry), software (e.g., executable code), or any combination thereof. Systems, devices, and components in FIG. 2 may be added, deleted, integrated, separated, and/or rearranged.

As shown in FIG. 2, the communication system 200 includes at least one vehicle 100, at least one network, shown as network 204, at least one server, shown as server 206, and at least one operator device, shown as operator device 210. The network 204 facilitates data communication between the components of the communication system 200. The server 206 stores, analyzes, and/or distributes data collected by the communication system 200. The operator devices 210 may facilitate communicating information to and from one or more operators of the vehicle 100.

As shown in FIG. 2, the communication system 200 includes at least one incident system, shown as alert system 220, that stores, analyzes, and/or distributes data collected by the communication system 200. According to the exemplary embodiment shown in FIG. 2, the alert system 220 is hosted by (e.g., located, performed, or executed on) the vehicle 100. In some embodiments, the alert system 220 is or is at least partially hosted by the server 206 and/or the operator devices 210. In some embodiments, the alert system 220 is an alert module (e.g., a black box, an alert device, etc.) that may be positioned at a scene of an incident. By way of example, the alert module may be carried by the vehicle 100 and deployed from (e.g., removed from, etc.) the vehicle 100 once the vehicle 100 arrives at the scene of the incident. By way of another example, the alert module may be located on the vehicle 100 and may be positioned at the scene of the incident once the vehicle 100 arrives at the scene of the incident.

As shown in FIG. 2, the alert system 220 includes a processing circuit 222 that includes at least one processor, shown as processor 224, and one or more memory devices, shown as memory 226. The memory 226 may include one or more devices (e.g., RAM, ROM, Flash memory, hard disk storage) for storing data. The memory 226 may also store computer code and/or instructions for executing, completing and/or facilitating the various processes described herein. For example, the memory 226 may store instructions and the instructions may cause the processors 224 to perform functionality that generates an alert relating to an incident or relating to the vehicle 100. The memory 226 may include non-transient volatile memory, non-volatile memory, and non-transitory computer storage media. The memory 226 may include database components, object code components, script components, or any other type of information structure for supporting the various activities and information structures described herein. The memory 226 may communicably couple with the processor 224. The memory 226 may also be electrically coupled with the processor 224. The processor 224 may be implemented as one or more application specific integrated circuits (ASICs), one or more field programmable gate arrays (FPGAs), a group of processing components, and/or other suitable electronic processing components.

As shown in FIG. 2, the vehicle 100 includes at least one sensor, shown as sensor 238, and at least one user interface (e.g., a display), shown as display device 240. The components of the vehicle 100 and/or the components of the communication system 200 may be electrically coupled with one another. For example, the processing circuit 222 may be electrically coupled with the sensors 238. The components of the vehicle 100 and/or the components of the communication system 200 may also communicate with, interact with, and/or otherwise interface with one another via a controller area network (CAN). For example, processing circuit 222 may communicate, via a CAN, with one or more of the sensors 238, the display devices 240, or the communication device 106.

The sensors 238 provide sensor data relating to the vehicle 100 (e.g., the status of the vehicle 100, the position of the vehicle 100, the surroundings of the vehicle 100, etc.). By way of example, the sensors 238 may accelerometers, tachometers, speedometers, GPS devices/sensors, temperature sensors, voltmeters, ammeters, radar sensors, pressure sensors, tactile sensors, photodetectors, motion sensors, proximity sensors, and/or among other possible sensors and/or devices. The sensors 238 may provide, to the alert system 220, operational data, status information, and telemetry data associated with the vehicle 100. The alert system 220 may utilize the data provided by the sensors 238 to generate the alert associated with the incident or with the vehicle 100. For example, if the sensors 238 provide sensor data relating to a speed of the vehicle 100 increasing, the alert system 220 may generate an alert based on the increase in speed.

In some embodiments, the sensors 238 provide data relating to a position or motion of the vehicle 100. By way of example, the sensors may include GPS sensors, accelerometers, or rotary speed sensor that provide a location of the vehicle 100, a speed of the vehicle 100, or an acceleration of the vehicle 100. By way of another example, the sensors 238 may indicate a position of the vehicle 100 relative to another object or vehicle (e.g., using a distance sensor). In some embodiments, the sensors 238 provide data relating to movement and/or actions performed and/or pertaining to controllable/movable elements of the vehicle 100. By way of example, the sensors 238 may indicate if a door or hood of the vehicle 100 is open or closed. By way of another example, the sensors 238 may indicate a rotational position, angle of incline, or extension length of a ladder of a fire apparatus. By way of another example, the sensors 238 may indicate the current position of one or more outriggers of the vehicle 100.

The sensors 238 may also record, determine, and/or otherwise collect measurement data regarding a current status of the vehicle 100. By way of example, the sensors 238 may determine an amount of a fluid stored on the vehicle 100 (e.g., fire suppressant foam, water, etc.). By way of another example, the sensors 238 may measure a State of Charge (SoC) for batteries disposed on the vehicle 100. By way of another example, the sensors 238 may measure a fluid or electrical property, such as a flow rate or pressure (e.g., of water to be projected from a monitor) or a current or voltage (e.g., being delivered from a battery).

The sensors 238 may collect data associated with faults, diagnostics, and telemetry data associated with the vehicle 100. Systems of and methods for collecting and analyzing fault, diagnostic, and telemetry data are described in U.S. patent application Ser. No. 18/093,600 filed on Jan. 5, 2023, the entirety of which is incorporated by reference herein.

The sensors 238 may include cameras. The cameras may be at least one of a video camera that captures video, a camera that captures images and/or among other possible optical instruments and/or optical devices that may capture, record, produce and/or otherwise provide videos and/or images. The cameras may also include audio devices. For example, the cameras may include at least one of a speaker, a microphone, a headphone, and/or among other possible audio and/or sound devices. The camera may provide video data to the alert system 220. The video data may include video feeds, images, recordings, audio files, audio signals and/or any other possible information that may be captured, produced and/or otherwise provided by the cameras.

The sensors 238 may be placed, located, situated, positioned, coupled and/or otherwise disposed on various components and/or locations on the vehicle 100. For example, a sensor 238 may be disposed on a front bumper of the vehicle 100. The information collected by the sensors 238 may be used by the communication system 200 to create a graphical representation of a location proximate to an incident. For example, the alert system 220 may collect image data provided by the sensors 238 to create, via a graphical user interface, a graphical representation of a location (e.g., an environment, a roadway, etc.) proximate to an incident or scene (e.g., an accident, a fire, a traffic stop, a construction site or zone, etc.). The graphical representation of the environment proximate to the incident or scene may include graphical representations of vehicles (e.g., the vehicle 100, surrounding vehicles, approaching vehicles, etc.), first responders, components of the vehicles, and/or pieces of equipment proximate to the incident or scene.

The display devices 240 may be and/or include a screen, a monitor, a visual display device, a television, a video display, a liquid crystal display (LCD), a light emitting diode (LED) display, an infotainment system, a mobile device, and/or among other possible displays and/or devices. For example, the display device 240 may be an infotainment system disposed within a cab of the vehicle 100. In some embodiments, the display device 240 is a touchscreen display that receives a touch input from a user. The display devices 240 may support any type of display feature, such as a flipbook-style animation, or any other type of transition feature. The display devices 240 may generally provide a plurality of navigation buttons that allow a user to select various displays and other options via touch.

The display device 240 may generate, produce, provide and/or otherwise display a user interface. For example, the display device 240 may display a user interface that includes video feeds provided by the sensors 238. The display device 240 may also display a user interface that includes graphical representations of a location proximate the vehicle 100 or proximate to an incident or scene. For example, the display device 240 may display a user interface that includes a graphical representation of a road that is proximate to a car accident. According to one such example, the graphical representation may include a number of lanes of the road, a direction of travel of the lanes of the road, or other information relating to the road. The display device 240 may also display a user interface and an operator of the display device 240 may input data (e.g., commands, selections, etc.) via the user interface. The display device 240 may provide the data inputted, via the user interface, to the communication system 200. For example, the display device 240 may receive, via a user interface, an activation of the communication system 200 and the display device 240 may provide the activation to the communication system 200. In other embodiments, the vehicle 100 includes other types of user interface devices, such as buttons, knobs, switches, sliders, microphones, or other input devices.

The communication device 106 of the vehicle 100 may interface with, interact with and/or otherwise communicate with at least one of the sensors 238, the display device 240, the server 206, the operator devices 210, and/or any other possible component of the vehicle 100. Accordingly, the communication device 106 may facilitate transferring data from external sources (e.g., the server 206, the operator devices 210, etc.) to the alert system 220.

The network 204 may be and/or include a local area network (LAN), wide area network (WAN), telephone network (such as the Public Switched Telephone Network (PSTN)), Controller Area Network (CAN), wireless link, intranet, the Internet, a cellular network and/or combinations thereof. The operator devices 210 may be and/or include at least one of a mobile computing device, a desktop computer, a smartphone, a tablet, a smart watch, a smart sensor and/or any other device that may facilitate providing, receiving, displaying and/or otherwise interacting with content (e.g., webpages, mobile applications, etc.).

An operator of the operator device 210 may perform various actions and/or access various types of information. The information may be provided over the network 204 (e.g., the Internet, LAN, WAN, cellular, etc.). Similarly, the operator device 210 may perform similar functionality to that of the display device 240. The operator device 210 may include an application to receive information, display information, and receive user interactions with the content. For example, the application may be a web browser and/or a mobile application. The operator of the operator device 210 may provide, via a user interface, data to the alert system 220 and/or the server 206. For example, the operator of the operator device 210 may provide, to the operator device 210, data indicating that a road proximate an incident is a two lane divided highway. As another example, the operator of the operator device 210 may provide, to the operator device 210, data including a summary of an incident.

The server 206 may be and/or include at least one of a remote device, an external database, a computing device, and/or among other possible computer hardware and/or computer software that may interface with, via the network 204, at least one of the vehicle 100, and/or the operator device 210. The server 206 includes at least one processing circuit, shown as processing circuit 250. The processing circuit 250 includes at least one processor, shown as processor 252, and memory, shown as memory 254. The processing circuit 250 and/or the components thereof (e.g., the processors 252 and the memory 254) may perform similar functionality to that of alert system 220 and/or a component thereof. The server 206 may also include, store, maintain and/or otherwise host the alert system 220. For example, the alert system 220 may be remote and/or external to the vehicle 100 and the vehicle 100 may communicate with the alert system 220. By way of another example, the alert system 220 may be distributed across one or more servers (e.g., the server 206) and one or more vehicles (e.g., the vehicle 100). In some embodiments, the server 206 facilitates distribution of data from the communication system 200 to external systems (e.g., third party data hosting platforms, external user devices, etc.).

As shown in FIG. 2, the alert system 220 includes a location tracker, shown as location tracker 232, an alert manager, shown as alert manager 234, and at least one database, shown as database 236. The location tracker 232 is configured to use collected data to determine the location of objects or individuals (e.g., the vehicle 100) within the communication system 200. The alert manager 234 is configured to analyze the various sources of data available to the alert system 220. The database 236 is configured to store data within the system. In some embodiments, the database 236 is configured to store alert parameters corresponding to alerts.

The alert parameters may be data, rules, and/or guidelines that may be used to determine an area that may be affected by the incident or scene, or by the vehicle 100. For example, the alert parameters stored by the database 236 may be used to define areas surrounding the vehicle 100 or an incident or scene where people should be alerted of the vehicle 100 or the incident or scene based on a type of incident or scene or a condition of the vehicle 100. In some embodiments, the alert parameters may be used to determine (a) a shape of the area that may be affected by the incident or scene, or by the vehicle 100 and/or (b) a size of the area that may be affected by the incident or scene, or by the vehicle 100. For example, the size of the area affected by a fire may depend on the size of the fire (e.g., a smaller fire results in a smaller area, a larger fire results in a larger area, etc.). As another example, a type of a road that the vehicle 100 is traveling on or located on may affect the shape of the area affected by the vehicle 100 (e.g., on a divided highway the area may only include a side of the divided highway that the vehicle 100 is traveling on, the area may be restricted to the road that the vehicle 100 is traveling on and not a surrounding area, etc.). As yet another example, a speed limit of a road that the vehicle 100 is traveling on may affect the size of the area affected by the vehicle 100 (e.g., the area may be larger for a high speed limit due to the vehicle 100 and approaching vehicles having a faster closing speed, the area may be smaller for a slower speed limit due to the vehicle 100 and approaching vehicles having a slower closing speed etc.). As yet another example, the actual speed of the vehicle 100 may affect the size of the area affected by the vehicle 100 (e.g., the area may be larger when the actual speed of the vehicle 100 or the speed limit is faster than when the actual speed of the vehicle 100 or the speed limit is slower, etc.).

In some embodiments, the alert parameters may be used to determine a frequency with which to distribute emergency alerts. By way of example, a speed limit of a road that the vehicle 100 is traveling on may affect the frequency with which the emergency alert is distributed (e.g., the frequency may be higher for a high speed limit due to the vehicle 100 having a faster closing speed, the frequency may be lower for a low speed limit due to the vehicle 100 having a slower closing speed, etc.). By way of anther example, a speed limit of a road that the vehicle 100 is parked near may affect the frequency with which the emergency alert is distributed (e.g., the frequency may be higher for a high speed limit due to other vehicles having faster closing speeds, the frequency may be lower for a low speed limit due to the other vehicles having slower closing speeds, etc.). By way of yet another example, a severity of an incident may affect the frequency with which the emergency alert is distributed (e.g., the frequency may be higher for an incident with a high severity, the frequency may be lower for an incident with a low severity, etc.). By way of yet another example, traffic conditions of a road proximate the incident may affect the frequency with which the emergency alert is distributed (e.g., the frequency may be higher for a road with low amount of traffic due to a high movement speed of the vehicles on the road, the frequency may be lower for a road with a high amount of traffic due to a low movement speed of vehicles on the road, etc.).

The location tracker 232 may be incorporated into (e.g., a function of) the processing circuit 222, or the location tracker 232 may be a function of another processing circuit within the communication system 200. The location tracker 232 may receive, from the communication device 106, data generated by the vehicle 100 and/or the operator devices 210. For example, the location tracker 232 may receive data collected by the sensors 238. By way of another example, the data utilized by the location tracker 232 may include location information (e.g., GPS coordinates, positional data, etc.) that is collected by the sensors 238 and/or the operator device 210.

The location tracker 232 may determine, using the data generated by the vehicle 100, a location of the vehicle 100. The determined location may be absolute (e.g., relative to the Earth) or relative (e.g., relative to an operating base of the vehicle 100). The location of the vehicle 100 may be proximate to an incident or scene (e.g., a fire, an accident, a construction site, etc.). For example, the location tracker 232 may determine that the vehicle 100 is located and/or otherwise position proximate to a fire. The location tracker 232 may receive, from the communication device 106, information pertaining to the incident or scene. For example, the location tracker 232 may receive an address of a building that is currently experiencing a fire. The location tracker 232 may, using the address of the building and the data generated by the vehicle 100, determine that the vehicle 100 is proximate to the building experiencing the fire. For example, the location tracker 232 may determine that the vehicle 100 is parked in front of the building. The location tracker 232 may provide, to the alert manager 234, the location of the vehicle 100 and the location of the incident.

The alert manager 234 may be incorporated into (e.g., a function of) the processing circuit 222, or the alert manager 234 may be a separate processing circuit within the alert system 220. In some embodiments, the alert manager 234 is configured to use alert data corresponding with an incident or with the vehicle 100 to generate an alert associated with the incident or with the vehicle 100. The alert data may include data from the vehicle 100, data from the server 206, data from the operator device, etc. that corresponds with the incident or with the vehicle 100. The alert manager 234 may be constantly in communication with a variety of different data sources, some of which may not be present at the incident (e.g., the server 206, the operator device 210, etc.). In some embodiments, the alert manager 234 is configured to model the alert data with the alert parameters to generate a distribution area associated with the alert. The distribution area may be an area where the alert will be wirelessly provided to users of user devices. For example, the alert data may correspond to a car accident. The alert manager 234 may generate an alert associated with the car accident and model the alert data with the alert parameters to determine a distribution area associated with the alert that includes an area within a distance of the car accident. The alert may include a title that identifies the incident or the vehicle 100 (e.g., “Fire Truck Approaching”, “Approaching Car Crash”, “Danger: Chemical Fumes”, etc.) and a summary that summarizes the incident or the vehicle 100 (e.g., “A fire truck is approaching your position, please move to your left”, “You are approaching a car crash, please slow down and move to your right”, “You are currently in an area identified as containing chemical fumes, please seek shelter”, etc.).

As shown in FIG. 2, the alert system 220 includes a user interface (e.g., switch, lever, touch screen, button, etc.), shown as alert user interface 242, configured to provide an operator with the ability to control one or more functions of and/or provide commands to the alert system 220. By way of example, the alert user interface 242 may include a button positioned on the alert module of the alert system 220 that is configured to control the activation of the communication system 200 to generate and provide emergency alerts. By way of another example, the alert user interface 242 may include a button configured to control the deactivation of the communication system 200 to stop providing emergency alerts. By way of yet another example, the alert user interface 242 may include a keypad configured to control the activation of the communication system 200 to generate and provide emergency alerts in response to receiving a passcode (e.g., a PIN, an access code, etc.) such that the emergency alerts are not provided until an authorization has been received by the alert user interface 242. By way of yet another example, the alert user interface 242 may include an authorization button (e.g., a confirmation button, etc.) that is configured to allow for the communication system 200 to provide the emergency alert after another button of the alert user interface 242 has controlled the activation of the communication system 200 to generate the emergency alert.

In some embodiments, the alert system 220 is configured to communicate with other alert systems 220 positioned at a location (e.g., via the network 204, etc.) when generating and/or distributing the alerts and/or the distribution areas associated with the alerts. By way of example a first of the alert systems 220 may utilize data received from a second of the alert systems 220 to generate the alert and/or the distribution area. By way of another example, a first of the alert systems 220 may provide the alert and/or the distribution to a second of the alert systems 220 associated with one of the vehicles 100 such that an operator of the one of the vehicles 100 is provided with the alert and/or the distribution area associated with the alert.

In some embodiments, the alert system 220 is configured to communicate with the other alert systems 220 positioned at the location to determine which of the alert systems 220 will generate and distribute the alert and/or the distribution area associated with the alert. By way of example, a first of the alert systems 220 associated with a first of the vehicles 100 positioned at an incident and a second of the alert systems 220 associated with a second of the vehicles 100 positioned at the incident may communicate via the network 204 to determined which of the first of the alert systems 220 or the second of the alert systems 220 will generate and distribute the alert and/or the distribution area so that multiple of the alerts and/or multiple of the distribution areas are not generated and/or distributed. The first of the alert systems 220 and the second of the alert systems 220 may determine which of the alert systems 220 will generate and distribute the alert and/or the distribution area based on the vehicles 100 associated with the alert systems 220. By way of example, the first of the alert systems 220 may take priority over the second of the alert systems 220 to generate and distribute the alert and/or the distribution data when the first of the vehicles 100 is a fire command vehicle and the second of the vehicles 100 is a fire fighting vehicle. By way of another example, the first of the alert systems 220 may take priority over the second of the alert systems 220 to generate and distribute the alert and/or the distribution data when the first of the vehicles 100 arrived at the scene before the second of the vehicles 10.

### Third-Party Integration

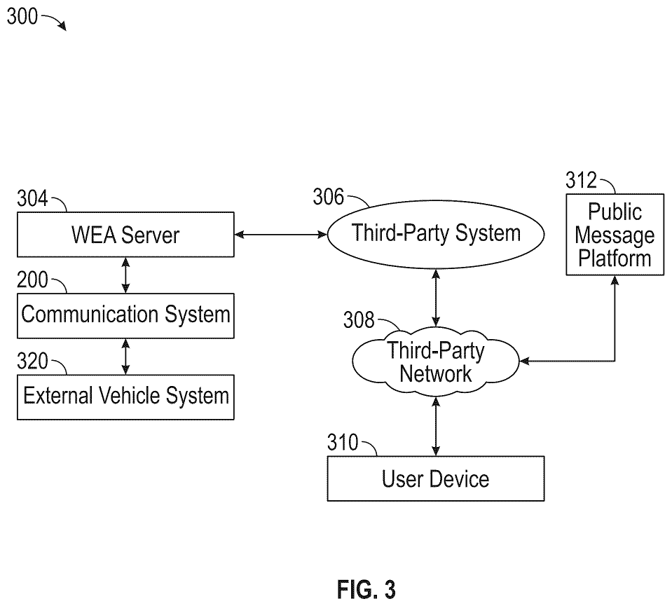

FIG. 3 depicts a block diagram of a wireless alert system, shown as wireless alert system 300, according to an exemplary embodiment. The wireless alert system 300 may include the communication system 200, a wireless alert server, shown as WEA server 304, at least one third-party system, shown as third-party system 306, at least one third-party network, shown as third-party network 308, at least one user device, shown as user device 310, and at least one public platform, shown as public message platform 312. FIG. 3 depicts an example of data transmission between the interconnected devices. For example, the communication system 200 may transmit data to the WEA server 304, and the WEA server 304 may transmit data to the communication system 200. The WEA server 304 may transmit data to the third-party systems 306, and the third-party systems 306 may transmit data to the WEA server 304. The third-party system 306 may transmit data to the user devices 310 and/or the public message platform 312 through the third-party network 308, and the user devices 310 and/or the public message platform 312 may transmit data to the third-party system 306 through the third-party network.

The WEA server 304 may receive, from the communication system 200, alert data including an alert relating to an incident or relating to the vehicle 100. The alert may include telemetry data, status of the incident, locational data pertaining to one or more vehicles (e.g., the vehicles 100), and/or other types of information related to the alert. For example, an alert relating to a fire in a building may include a summary that describes the fire in the building and the location of the building. In some embodiments, the WEA server 304 may receive, from the communication system 200, a distribution area associated with the alert relating to an area where the alert should be distributed. For example, the distribution area may be an area within a distance of the incident where the incident has been determined to be a hazard to people within the area. As another example, the distribution area may be an area within a path of the vehicle 100 where people in the path of the vehicle 100 should be warned that the vehicle 100 is approaching or nearby so that the people can get out of the way of the vehicle 100 or take caution. In some embodiments, the alert may include a sound associated with a type of the alert. For example, the alert may include a first sound if the alert is associated with the vehicle 100 responding to an incident or the alert may include a second sound if the alert is associated with the vehicle 100 that is already positioned proximate the incident or scene, or the incident or scene itself.

In some embodiments, the WEA server 304 may be part of government emergency broadcast system. For example, the WEA server 304 may be part of the wireless emergency alert program (e.g., the commercial mobile alert system, etc.) managed by the Federal Communications Commission (FCC) in the United States of America. In other embodiments, the WEA server 304 may be part of a local broadcast system (e.g., a broadcast system associated with an emergency responder, a broadcast system associated with a region, etc.). In some embodiments, the WEA server 304 may validate the information pertaining to the one or more alerts relating to the incident. For example, the WEA server 304 may validate that the alert is in a correct format (e.g., that the alert includes a summary of an incident, that the alert includes a location of the incident, that the alert includes a distribution area, etc.), that the information relating to the alert is provided from a proper source (e.g., a verified emergency responder, a verified response vehicle, etc.), or other details relating to the information.

In some embodiments, the WEA server 304 may modify the alert received from the communication system 200. For example, the alert received from the communication system 200 may not be in a standard format used by the WEA server 304. The WEA server 304 may modify the alert using information received form the communication system 200 such that the alert is in the standard form. In some embodiments, the WEA server 304 determines the distribution area associated with the alert based on information included in the alert received from the communication system 200.

The third-party systems 306 may receive, from the WEA server 304, the information pertaining to the one or more alerts relating to the incident. In some embodiments, the third-party systems 306 may be emergency alert systems of cellular service providers (e.g., a cellular carrier, etc.). For example, the WEA server 304 may distribute the information pertaining to the one or more alerts relating to the incident to the emergency alert systems of each of the cellular service providers servicing the distribution area (e.g., Verizon, AT&T, US Cellular, T-Mobile, etc.). As another example, the WEA server 304 may distribute the information pertaining to the one or more alerts relating to the incidents to the emergency alert systems of information service providers (e.g., television advertising service providers, billboard advertising service providers, construction sign service providers, etc.) servicing the distribution area.

The third-party system 306 may provide the alert to the user devices 310 and/or the public message platform 312 through the third-party network 308. In some embodiments, the third-party network 308 may be and/or include a local area network (LAN), wide area network (WAN), telephone network (such as the Public Switched Telephone Network (PSTN)), Controller Area Network (CAN), wireless link, intranet, the Internet, a cellular network and/or combinations thereof. In some embodiments, the third-party network 308 is a cellular network associated with one of the cellular service providers. For example, one of the third-party systems 306 may provide the alert to the user devices 310 associated with the third-party (e.g., user devices that receive service from the third party, etc.) over a cellular network of the third-party. As another example, one of the third-party systems 306 may provide the alert to the public message platform 312 associated with the third-party (e.g., public message devices that are operated by the third party, etc.) over a network of the third-party or a network utilized by the third-party. In some embodiments, the user devices 310 and/or the public message platform 312 may generate an alert interface and/or an audible alert corresponding to the alert and provide the alert interface to graphical user interfaces (GUI) of the user devices 310 and/or the public message platform 312.

In some embodiments, the third-party systems 306 may provide the alert to the user devices 310 and/or the public message platform 312 positioned within the distribution area of the alert. For example, the alert may specify the distribution area to distribute the alert and the third-party systems 306 may provide the alert to the user devices 310 and/or the public message platform 312 positioned within the distribution area. In some embodiments, the third-party systems 306 are configured to determine a coverage area of the third-party network 308 that contains an entirety of the distribution area of the alert and the third-party systems 306 may provide the alert to the user devices 310 and/or the public message platform 312 positioned within the coverage area. For example, a cellular network of a cellular service provider may include cellular towers. Each of the cellular towers may be configured to connect cellular phones within an operating area of the cellular tower to the cellular network. The third-party systems 306 may determine a portion of the cellular towers of the cellular network where a coverage area of a combination of the operating areas of the portion of the cellular towers contains the entirety of the distribution area of the alert. The third-party systems 306 may distribute the alert through the cellular towers of the cellular network to user devices 310 within the coverage area of the portion of the cellular towers such that all of the user devices 310 within the distribution area receive the alert. As another example, a billboard advertising provider may operate the public message platforms 312. The third-party systems 306 may determine a portion of the public message platforms 312 that are positioned within the distribution area of the alert. The third-party systems 306 may distribute the alert to the public message platforms 312 positioned within the distribution area of the alert such that all of the public message platforms 312 positioned within the distribution area receive the alert.

In some embodiments, the alert provided by the third-party systems 306 to the user devices 310 within the coverage area may include distribution data corresponding to the distribution area of the alert. Each of the user devices 310 may validate that the user device 310 is positioned within the distribution area, and if the user device 310 determines that the user device 310 is within the distribution area, the user device 310 may generate and provide the alert interface to the GUI of the user device 310. In some embodiments, the user devices 310 may determine if the user device 310 is within the distribution area through location information (e.g., GPS coordinates, positional data, etc.) that is collected by the user devices 310. For example, a third-party system 306 may determine a coverage area that fully contains a distribution area of an alert. The third-party system 306 may distribute the alert including distribution data corresponding to the distribution area to the user devices 310 located within the coverage area through the third-party network 308. The user devices 310 may utilize the distribution data to validate if each of the user devices 310 is located within the distribution area. If the user device 310 is located within the distribution area, then the user device 310 displays an alert interface corresponding to the alert to the GUI of the user device 310 such that the user of the user device 310 receives the alert. If the user device 310 is not located within the distribution area, then the user device 310 does not display the alert interface to the GUI of the user device 310 such that the user of the user device 310 does not receive the alert.

According to an exemplary embodiment, the integration and communication between the communication system 200 and the WEA server 304 facilitates providing advanced warning to people (e.g., the general population, citizens, pedestrians, drivers, etc.; in cars, outside, in houses, in buildings, etc.) (a) proximate or approaching an incident or scene, (b) proximate or approaching the vehicle 100, and (c) in the path of the vehicle 100 approaching them (i) without requiring people to download or otherwise have access to a special application or subscription on their user devices 310 and (ii) such that the people can take necessary precautionary measures (e.g., seek shelter, move over, take a detour, etc.). The user devices 310 may be or include a radio, a television, a cell phone, a smart phone, a tablet, a smart watch, a laptop, a desktop computer, a vehicle, and/or another other device that may be owned or operated by the general population that can communicate with the WEA server 304 and/or the third-party network 308. The public message platforms 312 may include a radio station, a television station, a billboard, an advertisement, a road sign, and/or another platforms or devices that may be perceived by members of the general population that can communicate with the WEA server 304, the third-party system 306, and/or the third-party network 308.

According to the exemplary embodiment shown in FIG. 3, the communication system 200 may transmit data to and/or receive data from at least one other vehicle, shown as external vehicle system 320. The external vehicle system 320 may be associated with one of the vehicles 100 that does not host the alert system 220. By way of example, a fleet of the vehicles 100 may be located at a scene of an incident. The fleet of vehicles may include the vehicle 100 that hosts the alert system 220 and a remainder of the vehicles 100 that include the external vehicle systems 320. The external vehicle systems 320 may provide data to the alert system 220 via the network 204 such that the data provided by the external vehicle system 320 may be utilized by the alert system 220 when generating the alert and/or the distribution area associated with the alert. In some embodiments, the external vehicle systems 320 may provide the alert and/or the distribution area associated with the alert to the communication system 200 so that the communication system 200 may provide the alert and the distribution area to the WEA server 304 (e.g., the communication system 200 may act as a repeater for the external vehicle system 320, etc.). By way of example, a first of the vehicles 100 at a scene may host the alert system 220 and a second of the vehicles 100 at the scene may include the external vehicle system 320 (e.g., not host the alert system 220, etc.). The external vehicle system 320 may generate the alert and the distribution area associated with the alert and provide the alert and the distribution area to the alert system 220 hosted by the first of the vehicles 100 so that the alert system 220 may provide the alert and the distribution area to the WEA server 304.

### Alert Environment

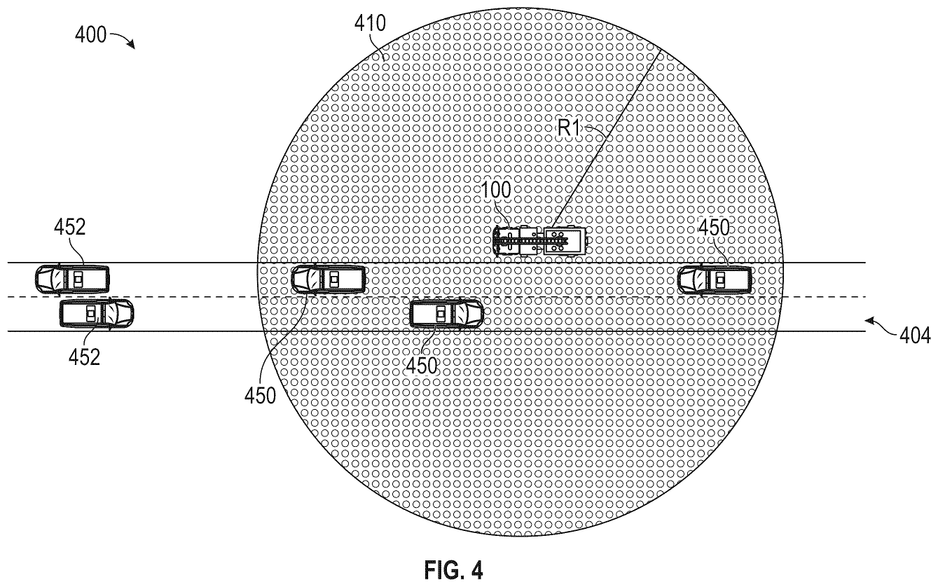

Referring to FIGS. 4-9, an alert environment, shown as alert environment 400 is shown. The alert environment 400 includes an incident or scene and/or the vehicle 100 associated with the incident or scene, an alert (e.g., a first alert, etc.) associated with the incident or scene and/or the vehicle 100, and a distribution area (e.g., a first distribution area, etc.) associated with the alert. In some embodiments, the alert environment 400 includes at least one of the vehicles 100 responding to the incident/scene. In some embodiments, the alert environment 400 includes at least one of the vehicles 100 present at the incident/scene. In some embodiments, the communication system 200 associated with the vehicle 100 is configured to receive or acquire alert data corresponding to the incident/scene and/or the vehicles 100 responding to or operating at the incident/scene. The communication system 200 generates the alert associated with the incident/scene and/or the vehicle 100. The communication system 200 also models the alert data with the alert parameters to generate the distribution area associated with the alert. In some embodiments, the distribution area is configured to be centered on the vehicle 100 or the incident. In some embodiments, the wireless alert system 300 receives the alert and the distribution area associated with the alert from the communication system 200. The wireless alert system 300 distributes the alert to the user devices 310. The user devices 310 positioned inside of the distribution area, shown as alerted user devices 450, display or provide the alert (e.g., an interface corresponding to the alert, a notification, an audible alert, etc.). The user devices 310 positioned outside of the distribution area, shown as unalerted user devices 452, do not display or provide the alert.

Referring to FIG. 4, an exemplary embodiment of the alert environment 400 includes the vehicle 100 stopped (e.g., parked, etc.) or operating at an incident or scene (e.g., a fire, an accident, a traffic stop, a work site, a construction zone, etc.) proximate a two-lane road (e.g., a non-divided road, a two-lane street, etc.), shown as two-lane road 404. The communication system 200 associated with the vehicle 100 receives or acquires alert data associated with the incident and generates an alert. The communication system 200 also models the alert data with the alert parameters and generates the distribution area with a circular shape, shown as circular distribution area 410. The circular distribution area 410 has a radius R1 and the center of the circular distribution area 410 is positioned at the vehicle 100. The circular distribution area 410 is configured to provide the user devices 310 within a distance of R1 of the vehicle 100 with the alert such that the users of the user devices 310 positioned near the incident are alerted of the incident. The wireless alert system 300 receives the alert and the circular distribution area 410 from the communication system 200, and provides the alert to the user devices 310 within the circular distribution area 410, i.e., the alerted user device 450. The alerted user devices 450 provide the alert (e.g., a notification, an audible sound, etc.). The unalerted user devices 452 positioned outside of the circular distribution area 410 do not provide the alert. By way of example, the alert may inform the users of the alerted user devices 450 that the vehicle 100 is stopped nearby and to proceed with caution (e.g., slow down, move a lane over if possible, etc.).

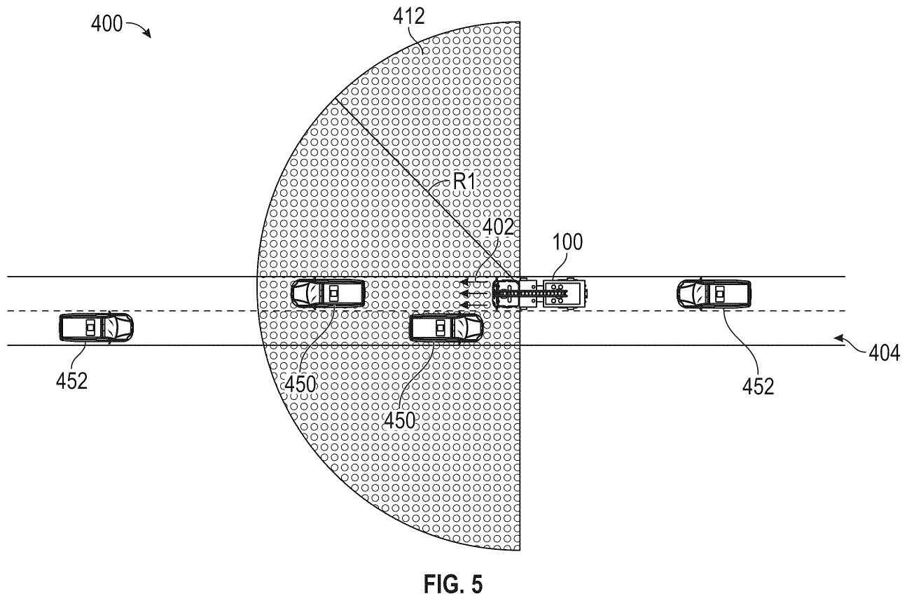

Referring to FIG. 5, an exemplary embodiment of the alert environment 400 includes the vehicle 100 responding to an incident or scene where the vehicle 100 is traveling (e.g., driving, moving, etc.) in a direction of travel, shown as direction of travel 402, on the two-lane road 404. The communication system 200 associated with the vehicle 100 receives or acquires alert data associated with the vehicle 100 and generates an alert. The communication system 200 also models the alert data with the alert parameters and generates the distribution area with a semi-circular shape, shown as semi-circular distribution area 412. The semi-circular distribution area 412 is oriented such that the semi-circular distribution area 412 is positioned forward of the vehicle 100 in the direction of travel 402. The semi-circular distribution area 412 has a radius R1 and the center of the semi-circular distribution area 412 is positioned at the vehicle 100. The semi-circular distribution area 412 is configured to provide the user devices 310 positioned within a distance of R1 forward or to the sides of the vehicle 100 with the alert such that the users of the user devices 310 positioned forward of the vehicle 100 in the direction of travel 402 or to the sides of the vehicle 100 are alerted that the vehicle 100 is approaching. The wireless alert system 300 receives the alert and the semi-circular distribution area 412 from the communication system 200 and provides the alert to the user devices 310 within the semi-circular distribution area 412, i.e., the alerted user device 450. The alerted user devices 450 positioned within the semi-circular distribution area 412 provide the alert (e.g., a notification, an audible sound, etc.). The unalerted user devices 452 positioned outside of the semi-circular distribution area 412 do not provide the alert. By way of example, the alert may inform the users of the alerted user devices 450 that the vehicle 100 is approaching from behind and to move over (e.g., pull to the shoulder).

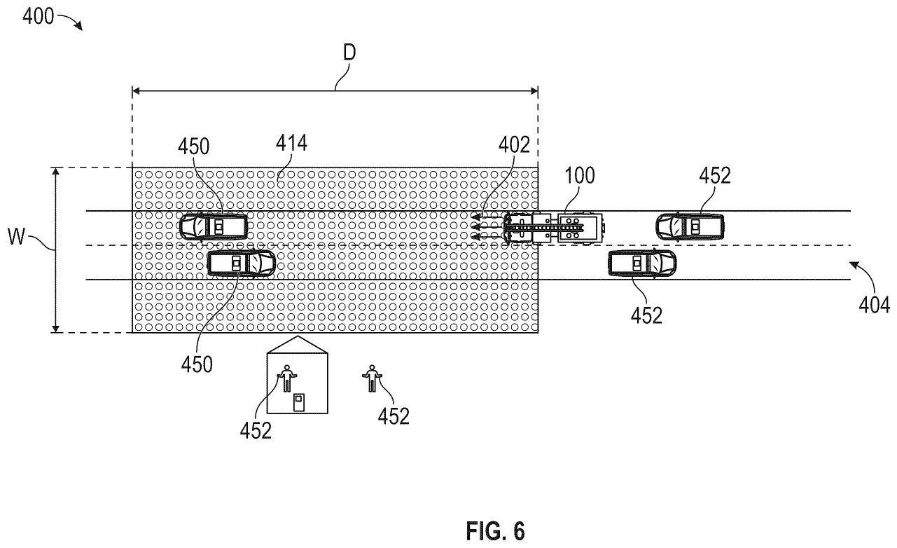

Referring to FIG. 6, an exemplary embodiment of the alert environment 400 includes the vehicle 100 responding to an incident or scene traveling in the direction of travel 402 on the two-lane road 404. The communication system 200 associated with the vehicle 100 receives or acquires the alert data associated with the vehicle 100 and generates the alert. The communication system 200 also models the alert data with the alert parameters and generates the distribution area with a rectangular shape, shown as rectangular distribution area 414. The rectangular distribution area 414 is oriented such that the rectangular distribution area 414 is positioned forward of the vehicle 100 in the direction of travel 402. The rectangular distribution area 414 has a length D from the vehicle 100 and a width W centered at the vehicle 100. The rectangular distribution area 414 is configured to provide the user devices 310 positioned forward of the vehicle 100 in the direction of travel 402 with the alert such that the users of the user devices 310 are alerted that the vehicle 100 is approaching. The rectangular distribution area 414 is also configured such that the user devices 310 that are not in front of the vehicle 100 or on the two-lane road 404 (e.g., in a house or building adjacent the road the vehicle 100 is driving along, behind the vehicle 100, etc.) are not provided with the alert since it is unlikely that the users of such user devices 310 will be affected by the vehicle 100 traveling on the two-lane road 404. The wireless alert system 300 receives the alert and the rectangular distribution area 414 from the communication system 200 and provides the alert to the user devices 310 within the rectangular distribution area 414, i.e., the alerted user device 450. The alerted user devices 450 positioned within the rectangular distribution area 414 provide the alert (e.g., a notification, an audible sound, etc.). The unalerted user devices 452 positioned outside of the rectangular distribution area 414 do not provide the alert. By way of example, the alert may inform the users of the alerted user devices 450 that the vehicle 100 is approaching from behind or ahead, and to move over (e.g., pull to the shoulder, slow down, etc.). The length D may be based on various attributes of the two-lane road 404. By way of example, the length D may be based on a speed limit of the two-lane road 404, a speed of the vehicle 100 traveling on the two-lane road 404, a speed of traffic on the two-lane road 404, etc.

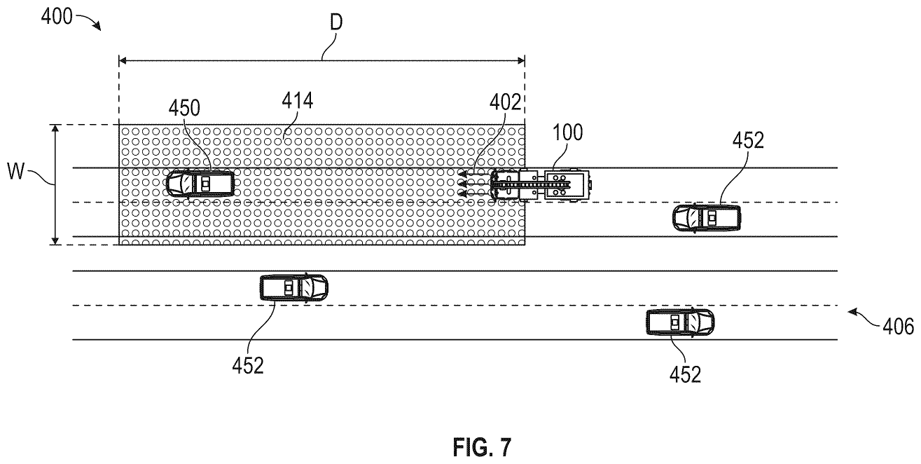

Referring to FIG. 7, an exemplary embodiment of the alert environment 400 includes the vehicle 100 responding to an incident or scene traveling in the direction of travel 402 on a divided road (e.g., a divided highway, a boulevard, etc.), shown as divided highway 406. The communication system 200 associated with the vehicle 100 receives or acquires the alert data associated with the vehicle 100 and generates the alert. The communication system 200 also models the alert data with the alert parameters and generates the distribution area with a rectangular shape, shown as the rectangular distribution area 414. The rectangular distribution area 414 is oriented such that the rectangular distribution area 414 is positioned forward of the vehicle 100 in the direction of travel 402. The rectangular distribution area 414 has the length D extending from the vehicle 100 in the direction of travel 402 and the width W centered at the vehicle 100. The rectangular distribution area 414 is configured to provide the user devices 310 positioned forward of the vehicle 100 on the same side of the divided highway 406 as the vehicle 100 with the alert such that the users of such user devices 310 are alerted that the vehicle 100 is approaching. The rectangular distribution area 414 is also configured such that the user devices 310 that are not positioned forward of the vehicle 100 on the same side of the divided highway 406 as the vehicle 100 and the user devices 310 on the opposite side of the divided highway 406 are not provided with the alert since it is unlikely that the users of such user devices 310 will be affected by the vehicle 100 traveling on the divided highway 406. The wireless alert system 300 receives the alert and the rectangular distribution area 414 from the communication system 200 and provides the alert to the user devices 310 within the rectangular distribution area 414, i.e., the alerted user device 450. The alerted user devices 450 positioned within the rectangular distribution area 414 provide the alert (e.g., a notification, an audible sound, etc.). The unalerted user devices 452 positioned outside of the rectangular distribution area 414 do not provide the alert. By way of example, the alert may inform the users of the alerted user devices 450 that the vehicle 100 is approaching from behind and to move over (e.g., pull to the shoulder).

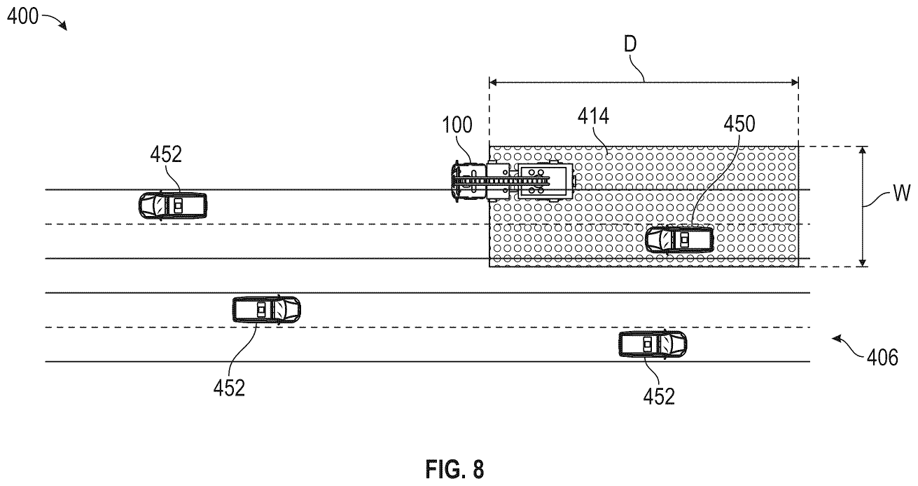

Referring to FIG. 8, an exemplary embodiment of the alert environment 400 includes the vehicle 100 stopped (e.g., parked, etc.) or operating at an incident or scene (e.g., a fire, an accident, a traffic stop, a work site, a construction zone, etc.) proximate the divided highway 406. The communication system 200 associated with the vehicle 100 receives or acquires the alert data associated with the incident and generates the alert. The communication system 200 also models the alert data with the alert parameters and generates the distribution area, shown as the rectangular distribution area 414. The rectangular distribution area 414 is oriented such that the rectangular distribution area 414 is positioned rearward of the vehicle 100. The rectangular distribution area 414 has the length D extending rearward from the vehicle 100 and the width W centered at the vehicle 100. The rectangular distribution area 414 is configured to provide the user devices 310 positioned rearward of the vehicle 100 on the same side of the divided highway 406 as the vehicle 100 with the alert such that the users of the user devices 310 are alerted they are approaching the vehicle 100. The rectangular distribution area 414 is also configured such that the user devices 310 that are not positioned rearward of the vehicle 100 on the same side of the divided highway 406 as the vehicle 100 and the user devices 310 on the opposite side of the divided highway 406 are not provided with the alert since it is unlikely that the users of the user devices 310 will be affected by the vehicle 100 parked proximate the divided highway 406. The wireless alert system 300 receives the alert and the rectangular distribution area 414 from the communication system 200 and provides the alert to the user devices 310 within the rectangular distribution area 414, i.e., the alerted user device 450. The alerted user devices 450 positioned within the rectangular distribution area 414 provide the alert (e.g., a notification, an audible sound, etc.). The unalerted user devices 452 positioned outside of the rectangular distribution area 414 do not display the alert interface. By way of example, the alert may inform the users of the alerted user devices 450 that the vehicle 100 is approaching from behind and to move over (e.g., pull to the shoulder). By way of example, the alert may inform the users of the alerted user devices 450 that the vehicle 100 is stopped nearby and to proceed with caution (e.g., slow down, move a lane over if possible, etc.).

In some embodiments, the length D of the rectangular distribution area 414 may be modified based on a speed limit of a road that the vehicle 100 is positioned on or an actual speed of the vehicle 100. For example, when the vehicle 100 is traveling at a first speed, the length D may be a first length and when the vehicle 100 is traveling at a second speed that is slower than the first speed, the length D may be a second length that is smaller than the first length. As another example, when the speed limit of a first road is a first speed limit and the speed limit of a second road is a second speed limit that is higher than the first speed limit, the length D may be a first length for the first road and a second length for the second road that is longer than the first length since vehicles on the second road traveling at the second speed limit with cover distances faster than vehicles on the first road traveling at the first speed limit.

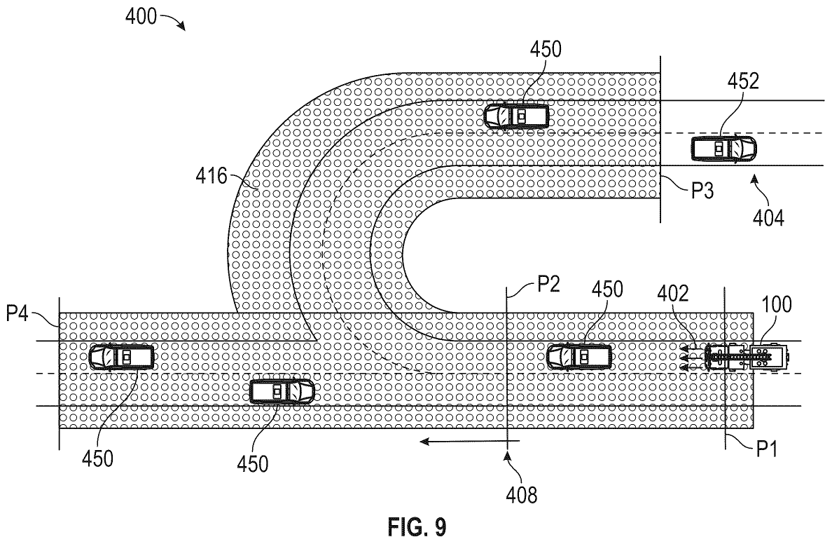

Referring to FIG. 9, an exemplary embodiment of the alert environment 400 includes the vehicle 100 responding to an incident or scene traveling in the direction of travel 402 on the two-lane road 404. The two-lane road 404 includes a split, shown as split 408 (e.g., a fork, a division, etc.) where the two-lane road 404 splits into two different directions. The communication system 200 associated with the vehicle 100 receives or acquires the alert data associated with the vehicle 100 and generates the alert. The communication system 200 also models the alert data with the alert parameters and generates the distribution area, shown as variable distribution area 416. The variable distribution area 416 is oriented such that the variable distribution area 416 is positioned along the two-lane road 404 in the direction of travel 402 of the vehicle 100. The variable distribution area 416 is positioned along the two-lane road 404 in both of the directions of the two-lane road 404 after the split 408. The variable distribution area 416 is configured to provide the user devices 310 positioned forward of the vehicle 100 in the direction of travel 402 of the vehicle 100 in both of the directions of the two-lane road 404 after the split 408 with the alert such that the users of the user devices 310 are alerted that the vehicle 100 is approaching since the vehicle 100 may travel in either of the directions of the two-lane road 404 after the split 408. The wireless alert system 300 receives the alert and the variable distribution area 416 from the communication system 200 and provides the alert to the user devices 310 within the variable distribution area 416, i.e., the alerted user device 450. The alerted user devices 450 positioned within the variable distribution area 416 provide the alert (e.g., a notification, an audible sound, etc.). The unalerted user devices 452 positioned outside of the variable distribution area 416 do not provide the alert.

In some embodiments, a distance that the variable distribution area 416 is positioned along each of the directions of the two-lane road 404 after the split 408 may be different based on properties of the two-lane road 404. For example, the variable distribution area 416 may extend from the vehicle 100 to the split 408 in the two-lane road 404 from point P1 to point P2. The variable distribution area 416 may extend past the split 408 in the two-lane road 404 in a first direction from the point P2 to the point P3 and in a second direction from the point P2 to point P4. A first distance along the two-lane road 404 from the point P1 to the point P3 may be different from a second distance along the two-lane road 404 from the point P1 to the point P4. For example, the first distance from the point P1 to the point P3 may be shorter than the second distance from the point P1 to the point P4 if a first speed limit for the section of the two-lane road 404 between the point P2 and the point P3 is less than a second speed limit for the section of the two-lane road 404 between the point P2 and the point P4.

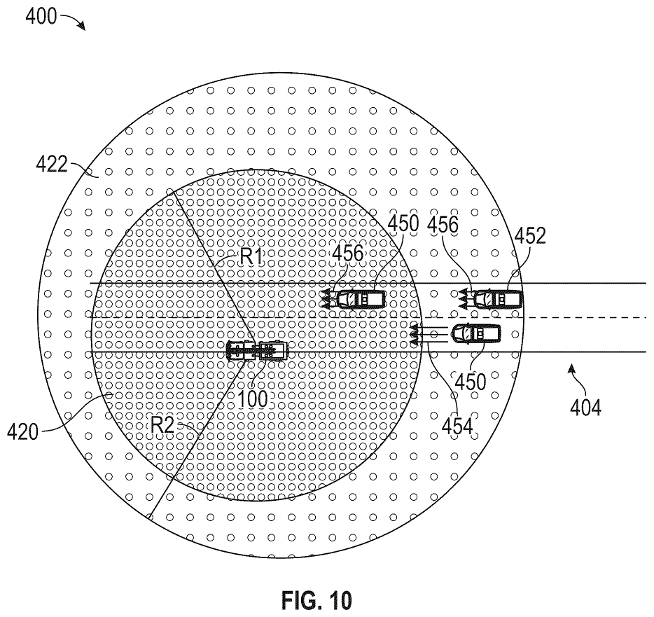

Referring to FIG. 10, an exemplary embodiment of the alert environment 400 includes the vehicle 100 stopped (e.g., parked, etc.) or operating at an incident or scene (e.g., a fire, an accident, a traffic stop, a work site, a construction zone, etc.) along or proximate a two-lane road 404. The communication system 200 associated with the vehicle 100 receives or acquires the alert data associated with the incident and generates the alert. The communication system 200 also models the alert data with the alert parameters and generates a first distribution area with a circular shape, shown as first circular distribution area 420, and a second distribution area with a circular shape, shown as second circular distribution area 422. The first circular distribution area 420 has a radius R1 and the center of the first circular distribution area 420 is positioned at the vehicle 100. The second circular distribution area 422 has a radius R2 that is larger than the radius R1 of the first circular distribution area 420 and the center of the second circular distribution area is positioned at the vehicle 100. The first circular distribution area 420 is configured to provide the user devices 310 within a distance of R1 of the vehicle 100 with the alert such that the users of such user devices 310 positioned near the incident are alerted of the incident.

The second circular distribution area 422 is configured to facilitate providing the user devices 310 traveling a faster, first speed 454 within a distance of R2 of the vehicle 100 with the alert such that the users of the user devices 310 positioned near the incident traveling faster are alerted of the incident sooner than user devices 310 traveling at a slower, second speed 456. The first circular distribution area 420 is configured to facilitate providing the user devices 310 within a distance of R1 of the vehicle 100 and traveling the second speed 456 with the alert such that the users of the user devices 310 positioned near the incident are alerted of the incident. The wireless alert system 300 receives the alerts, the first circular distribution area 420, the first speed 454, the second circular distribution area 422, and/or the second speed 456 from the communication system 200 and provides the alerts to the user devices 310. The wireless alert system 300 provides (a) first alerts to the user devices 310 outside of the first circular distribution area 420 but inside of the second circular distribution area 422 that are traveling at or above the first speed 454 and approaching the vehicle 100 and (b) second alerts to the user devices 310 inside of the first circular distribution area 420 that are traveling below the first speed 454 and approaching the vehicle 100. The alerted user devices 450 (i) positioned within the first circular distribution area 420 and (ii) positioned within the second circular distribution area 422 and traveling at or faster than the first speed 454 provide the alerts. The unalerted user devices 452 (i) positioned outside of the second circular distribution area 422 or (ii) positioned outside of the first circular distribution area 420 and traveling slower than the first speed 454 do not provide the alerts.

### Dual-Alert Environment

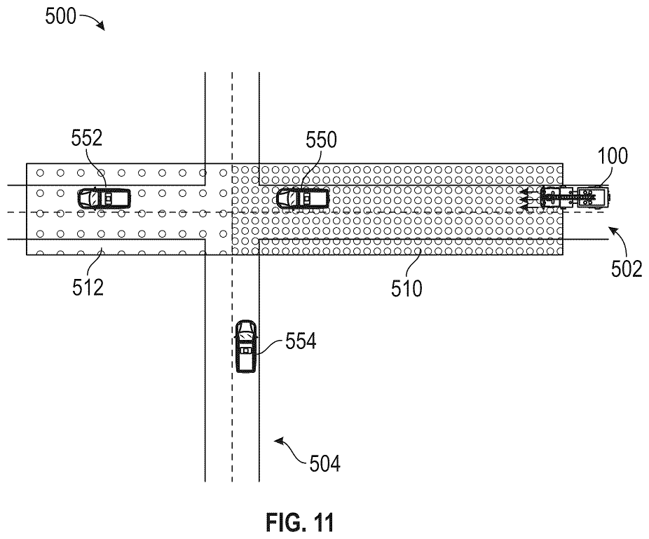

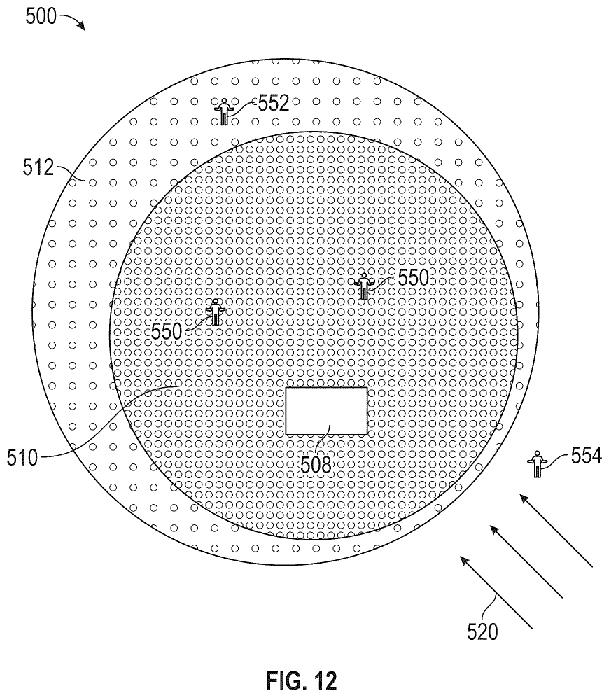

Referring to FIGS. 11 and 12, a dual-alert environment, shown as dual-alert environment 500, is shown. The dual-alert environment 500 includes an incident or a vehicle 100, a first alert associated with the incident or the vehicle 100, a first distribution area, shown as first distribution area 510, associated with the first alert, a second alert associated with the incident or the vehicle 100, and a second distribution area, shown as second distribution area 512, associated with the second alert. The first distribution area 510 includes a first area that is affected by the incident or the vehicle 100. The first alert may be configured to warn the users of the user devices 310 positioned within the first distribution area 510 that they are affected by the incident or the vehicle 100. The second distribution area 512 includes a second area that is predicted to be affected by the incident or the vehicle 100. The second alert may be configured to warn the users of the users of the user devices 310 positioned within the second distribution area 512 that they may be affected by the incident or the vehicle 100. In some embodiments, the communication system 200 associated with the vehicle 100 receives or acquires the alert data associated with the incident or the vehicle 100 and generates the first alert and the second alert. The communication system 200 also models the alert data with the alert parameters and generates the first distribution area 510 associated with the first alert and the second distribution area 512 associated with the second alert. In some embodiments, the wireless alert system 300 receives the first alert, the first distribution area 510, the second alert, and the second distribution area 512 from the communication system 200. The wireless alert system 300 distributes the first alert and the second alert to the user devices 310. The user devices 310 positioned inside of the first distribution area 510, shown as first alerted user devices 550, provide the first alert. The user devices 310 positioned inside of the second distribution area 512, shown as second alerted user devices 552, provide the second alert. The user devices 310 positioned outside of the first distribution area 510 and the second distribution area 512, shown as unalerted user devices 554, do not provide the first alert of the second alert.

Referring to FIG. 11, an exemplary embodiment of the dual-alert environment 500 includes the vehicle 100 responding to an incident or scene traveling down a road, shown as road 502. The communication system 200 associated with the vehicle 100 receives or acquires the alert data associated with the vehicle 100 and generates the first alert and the second alert. The communication system 200 also models the alert data with the alert parameters and generates the first distribution area 510 associated with the first alert and the second distribution area 512 associated with the second alert. The first distribution area 510 is configured to facilitate providing the user devices 310 positioned forward of the vehicle 100 with the first alert such that the users of the user devices 310 within the first distribution area 510 are alerted that the vehicle 100 is approaching. In some embodiments, the first distribution area 510 is configured to extend from the vehicle 100 to an intersection where the road 502 intersects with a second road 504. The second distribution area 512 is configured to facilitate providing the user devices 310 positioned forward of the first distribution area 510 with the second alert such that the users of the user devices 310 within the second distribution area 512 are alerted that the vehicle 100 may be approaching, as it is possible that the vehicle 100 may turn from the road 502 onto the second road 504 at the intersection and not continue on the road 502 after passing through the intersection. The wireless alert system 300 receives the first alert, the second alert, the first distribution area 510, and the second distribution area 512 from the communication system 200 and provides the alerts to the user devices 310. The first alerted user devices 550 positioned within the first distribution area 510 provide the first alert. The second alerted user devices 552 positioned within the second distribution area 512 provide the second alert. The unalerted user devices 554 positioned outside of the first distribution area 510 and the second distribution area 512 do not provide an alert.

Referring to FIG. 12, an exemplary embodiment of the dual-alert environment 500 includes an incident source, shown as incident source 508. In some embodiments, the incident source 508 may be a chemical spill, a fire, a nuclear accident, an active shooter, a hurricane, or another type of incident that may create a hazard in a first area with a potential to create a hazard in a second area. The communication system 200 associated with the vehicle 100 receives or acquires the alert data associated with the incident source 508 and generates the alert. The communication system 200 also models the alert data with the alert parameters and generates the first distribution area 510 associated with the first alert and the second distribution area 512 associated with the second alert. The first distribution area 510 is configured to facilitate providing the user devices 310 positioned in a first area affected by the incident source 508 from the incident source 508 with the first alert such that the users of the user devices 310 are alerted that they are affected by the incident source 508 (e.g., seek shelter, evacuate, etc.). In some embodiments, the first distribution area 510 is configured to extend from the incident source 508 based on incident data including information relating to the incident (e.g., the type of the hazard created by the incident, weather conditions around the incident, etc.). In some embodiments, the incident data includes wind data, shown as wind profile 520, which may direct the hazard created by the incident source 508. The second distribution area 512 is configured to provide the user devices 310 positioned in a second area that may be affected by the incident from the incident source 508 with the second alert such that the users of the user devices 310 are alerted that they may be affected by the incident source 508 (e.g., to seek shelter, to evacuate, affected due to changing wind patterns of the wind profile 520). In some embodiments, the second distribution area 512 is configured to extend from the incident source 508 based on the incident data. The wireless alert system 300 receives the first alert, the second alert, the first distribution area 510, and the second distribution area 512 from the communication system 200 and provides the alert to the user devices 310. The first alerted user devices 550 positioned within the first distribution area 510 provide the first alert. The second alerted user devices 552 positioned within the second distribution area 512 provide the second alert. The unalerted user devices 554 positioned outside of the first distribution area 510 and the second distribution area 512 do provide the first alert or the second alert.

As an example, the incident source 508 may be a chemical spill or fire that releases harmful pollutants into the air. At a first point in time, a first area may be affected by such pollutants such that users within the first area are alerted of the potential harmful impact of being outside or in the first area. However, the wind profile 520 may change over time such that a larger area is affected or the area that is affect shifts to a second area. Therefore, over time, alerts may be sent to additional users in the larger area or the users within the second area. Users no longer affected may be sent an alert that conditions have returned to normal or safe levels.

### Alert Method

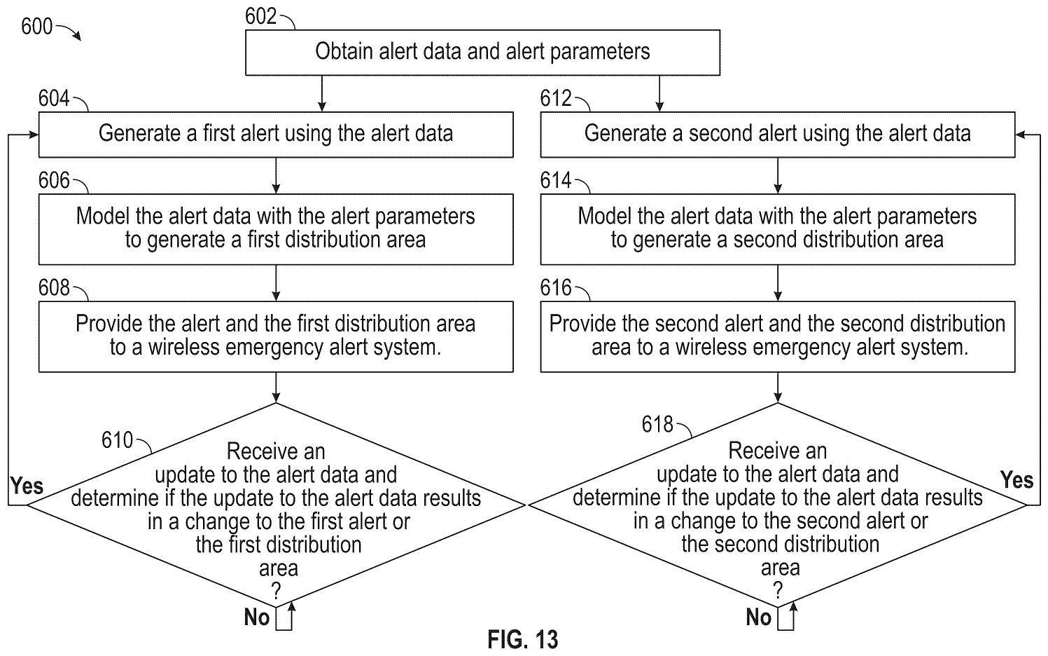

Referring now to FIG. 13, a flow chart of a process 600 for wirelessly providing an alert is shown, according to an exemplary embodiment. Process 600 may be executed by, for example, the communication system 200 and the wireless alert system 300. Further, any computing device described herein can be configured to perform process 600 (e.g., processing circuit 222 of the vehicle 100, processing circuit 250 of the server 206, the operator device 210, etc.).

In some embodiments, process 600 begins in response to receiving an activation of an alert system (e.g., receiving the activation of the alert system occurs prior to beginning the process 600, etc.). For example, the alert system may be activated by an operator activating the alert system (e.g., through the operator device 210, through the vehicle 100, through the alert user interface 242 of the alert system 220, etc.), by a vehicle due to a condition of the vehicle (e.g., upon arriving at an incident, upon leaving an operation base, upon traveling faster than a predetermined speed, a speed of the vehicle 100 exceeding a threshold, upon a sensor reading a value over a predetermined threshold, upon the vehicle 100 being placed in a parked configuration, when the vehicle 100 is positioned on a public road, upon a sensor 238 detecting that a ladder of the vehicle 100 is extended, upon the sensors 238 detecting that the outriggers of the vehicle 100 are extended, upon the emergency lights 102 and/or the speakers 104 of the vehicle 100 being activated, etc.), or by a server (e.g., the server 206, upon receiving a report on an incident, upon receiving an indication that the vehicle 100 was dispatched to the incident, etc.). In some embodiments, the activation of the alert system is performed automatically (e.g., based on the condition of the vehicle, based on the location of the vehicle, etc.). In other embodiments, the activation of the alert system is performed manually. By way of example, the activation of the alert system may be performed by an operator inputting a user input associated with the activation of the alert system. By way of another example, the activation of the alert system may be performed by an operator inputting a first user input associated with the activation of the alert system and a second user input associated with an authorization of the activation of the alert system. By way of yet another example, the activation of the alert system may be performed by an operator inputting a first user input associated with the activation of the alert system and a second user input associated with a confirmation of the activation of the alert system.

Process 600 includes obtaining alert data and alert parameters (step 602), according to some embodiments. The alert data may relate to an incident (e.g., a summary of the incident, a location of the incident, an environment surrounding an incident, etc.) or a vehicle responding to the incident (e.g., a location of the response vehicle, a route of the response vehicle, a speed of the response vehicle, an environment surrounding the response vehicle, etc.). In some embodiments, the alert data may be provided by at least one of an operator of the vehicle (e.g., through an operator device, through an interface of the vehicle, etc.), from a response vehicle, or from a server. In various embodiments, the alert data may be provided by more than one of the operator of the vehicle, the vehicle, and the server. For example, the server may provide the alert data including the location of the incident and the vehicle may provide the alert data including the location of the vehicle. The alert parameters may be data, rules, and/or guidelines that may be used to determine a distribution area for the alert associated with the incident or with the vehicle.

In some embodiments, the communication system 200 may obtain the alert data from at the alert system 220 of the vehicle 100, the operator device 210, and/or the server 206. For example, the server 206 may provide the alert data to the communication system 200 after a dispatcher inputs a location of an incident and a summary of the incident into the server 206. As another example, the alert system 220 of the vehicle 100 may provide the alert data to the communication system 200 including a location of the vehicle 100 from the location tracker 232 and a speed of the vehicle 100 determined by the sensors 238. In some embodiments, the communication system 200 may obtain the alert parameters from the database 236 of the vehicle 100 or the communication system 200 may need to receive additional alert parameters from a different source (e.g., the server 206, the operator device 210, etc.)

Process 600 further includes generating a first alert using the alert data (step 604), according to some embodiments. The first alert may include information relating to the incident (e.g., a summary of the incident, a location of the incident, a title relating to the incident, etc.) or information relating to the vehicle responding to the incident (e.g., a location of the response vehicle, a summary of a condition of the response vehicle, a title relating to the response vehicle, etc.). In some embodiments, the first alert may include a warning that the person receiving the first alert will be affected by the incident or the vehicle. For example, the first alert may include a warning that the person receiving the first alert is approaching the side of an accident. As another example, the first alert may include a warning that the person receiving the first alert is within an area affected by a chemical spill and that the person should take shelter. In some embodiments, the first alert may include information that is required by a wireless emergency alert system. For example, the wireless emergency alert system may require that the first alert include a title, a summary, and a location. In some embodiments, step 604 may be performed by the communication system 200 based on the alert data received from at least one of the operator device 210, the alert system 220 of the vehicle 100, or the server 206. For example, the communication system 200 may generate the first alert associated with the incident using a summary of the incident received from the server 206 and a location of the vehicle 100 received from the alert system 220 of the vehicle 100. As another example, the communication system 200 may generate the first alert associated with the incident using the alert data received from the operator device 210 that includes information inputted by an operator of the operator device 210.

Process 600 further includes modeling the alert data with the alert parameters to generate a first distribution area (step 606), according to some embodiments. The first distribution area may correspond to an area where the first alert should be distributed based on the alert data and the alert parameters. In some embodiments, the first distribution area corresponds to an area that is affected by the incident or the response vehicle. For example, the alert data may be related to a response vehicle responding to an incident that is traveling along a two-lane road. The alert data may be modeled with the alert parameters to generate the first distribution area that is configured as a rectangular distribution area located forward of the response vehicle in a direction of travel of the response vehicle such that people located on the two-lane road forward of the response vehicle are located in the rectangular distribution area. As another example, the alert data may be related to an incident on a side of a divided highway. The alert data may be modeled with the alert parameters to generate the first distribution area that is configured as a rectangular distribution area located rearward of the incident such that people located the side of the divided highway that area approaching the incident are located in the rectangular distribution area. In some embodiments, the first distribution area may be generated by the communication system 200.

Process 600 further includes providing the first alert and the first distribution area to a wireless emergency alert system (step 608), according to some embodiments. The wireless emergency alert system may be configured to validate the first alert and wirelessly provide the first alert to users of user devices located within the first distribution area. In some embodiments, the communication system 200 may provide the first alert and the first distribution area to the wireless alert system 300 or the WEA server 304. In some embodiments, the wireless emergency alert system is configured to provide the first alert and the first distribution area to the wireless emergency alert system with a first frequency. The alert data may be modeled with the alert parameters to generate the first frequency. By way of example, the first frequency may be based on a speed of the vehicle, a speed limit of a road positioned proximate the vehicle, a severity of an incident associated with the alert data, etc.)

Process 600 further includes receiving an update to the alert data and determining if the update to the alert data results in a change to the first alert or the first distribution area (step 610), according to some embodiments. The update to the alert data may be related to a change associated with the incident or a change associated with the response vehicle. For example, the incident may increase in size (e.g., a fire may grow bigger, an accident may be expanded to include additional vehicles, etc.), which would result in an update to a summary of the incident included in the first alert or the first distribution area corresponding to the first alert increasing in size. As another example, the response vehicle may increase in speed, which would result in an update to the first distribution area to increase the size of the first distribution area when the first distribution area includes an area that the response vehicle is projected to reach in a predetermined amount of time.

In response to the update to the alert data resulting in an update to the first alert or first the distribution area (step 610 “YES”), process 600 returns to step 604. In response to the update to the alert data not resulting in an update to the first alert or the first distribution area (step 610, “NO”), process 600 returns to step 610.

Process 600 further includes generating a second alert using the alert data (step 612), according to some embodiments. The second alert may include information relating to the incident or information relating to the response vehicle responding to the incident. In some embodiments, the second alert may include a warning the person receiving the second alert is predicted to be affected by the incident or the response vehicle. For example, the second alert may include a warning that the person receiving the second alert is in a path that the response vehicle is predicted to take, but that the response vehicle may take another path. As another example, the second alert may include a warning that the person receiving the second alert is within an area that is predicted to be affected by a chemical spill and that the person should consider taking shelter within an amount of time that corresponds with a time before the chemical spill is predicted to affect the area. In some embodiments, the second alert may include the information that is required by a wireless emergency alert system. In some embodiments, step 604 may be performed by the communication system 200 based on the alert data received from at least one of the operator device 210, the alert system 220 of the vehicle 100, or the server 206.

Process 600 further includes modeling the alert data with the alert parameters to generate a second distribution area (step 614), according to some embodiments. The second distribution area may correspond to an area where the second alert should be distributed based on the alert data and the alert parameters. In some embodiments, the second distribution area does not overlap with the first distribution area, such that the people who receive the first alert do not receive the second alert. In some embodiments, the second distribution area corresponds to an area that is predicted to be affected by the incident or the response vehicle. For example, the alert data may be related to a response vehicle responding to an incident that is traveling along a two-lane road with an intersection located forward of the response vehicle in a direction of travel of the response vehicle. The alert data may be modeled with the alert parameters to generate the first distribution area that is configured as a first rectangular distribution area located from the response vehicle to the intersection and the second distribution area that is configured as a second rectangular distribution area located forward of the intersection (e.g., forward of the first rectangular distribution area). The first rectangular distribution area is configured such that people located on the two-lane road between the response vehicle and the intersection will be provided with the first alert since the response vehicle will travel through the first rectangular distribution area. The second rectangular distribution area is configured such that people located on the two-lane road beyond the intersection will be provided with the second alert since the response vehicle is predicted to travel through the second rectangular distribution area, but may instead turn at the intersection and not travel through the second rectangular distribution area. As another example, the alert data may be related to a chemical spill releasing toxic fumes. The alert data may be modeled with the alert parameters to generate the first distribution area that is configured to include a first area where the toxic fumes are a hazard and the second distribution area that includes a second area where the toxic fumes are predicted to be a hazard in the future. In some embodiments, the second distribution area may be generated by the communication system 200.

Process 600 further includes providing the second alert and the second distribution area to a wireless emergency alert system (step 616), according to some embodiments. The wireless emergency alert system may be configured to validate the second alert and wirelessly provide the second alert to users of user devices located within the second distribution area. In some embodiments, the communication system 200 may provide the second alert and the second distribution area to the wireless alert system 300 or the WEA server 304. In some embodiments, the wireless emergency alert system is configured to provide the second alert and the second distribution area to the wireless emergency alert system with a second frequency. The alert data may be modeled with the alert parameters to generate the second frequency. By way of example, the second frequency may be based on a speed of the vehicle, a speed limit of a road positioned proximate the vehicle, a severity of an incident associated with the alert data, etc.)

Process 600 further includes receiving an update to the alert data and determining if the update to the alert data results in a change to the second alert or the second distribution area (step 618), according to some embodiments. The update to the alert data may be related to a change associated with the incident or a change associated with the response vehicle. For example, if the alert data relates to a chemical spill that is releasing toxic fumes, the second distribution area for the second alert relating to an area where the toxic fumes are predicted to be a hazard in the future may change when the alert data is updated to include a different wind direction. As another example, when the response vehicle travels through an intersection and into the second distribution area, the first distribution area may replace the second distribution area and the second distribution area may be changed to be positioned beyond the new position of the first distribution area.

In response to the update to the alert data resulting in an update to the second alert or the second distribution area (step 618 “YES”), process 600 returns to step 612. In response to the update to the alert data not resulting in an update to the second alert or the second distribution area (step 618, “NO”), process 600 returns to step 618.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, orientations, etc.). By way of example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions, and arrangement of the exemplary embodiments without departing from the scope of the present disclosure.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media may be any available media that may be accessed by a general purpose or special purpose computer or other machine with a processor. By way of example, such machine-readable media may comprise RAM, ROM, EPROM, EEPROM, or other optical disk storage, magnetic disk storage or other magnetic storage devices, or any other medium which may be used to carry or store desired program code in the form of machine-executable instructions or data structures and which may be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

1. An alert system comprising:
one or more processing circuits configured to:
acquire alert data regarding at least one of an incident or a response vehicle at or responding to the incident;
determine, based on the alert data, a distribution area for an alert; and
provide the alert data and the distribution area to a wireless emergency alert system, wherein the wireless emergency alert system is configured to distribute the alert including the alert data to user devices positioned within the distribution area, and wherein the wireless emergency alert system is configured to communicate with the user devices without requiring the user devices to download or have access to an application or subscription associated with the wireless emergency alert system.

2. The alert system of claim 1, wherein the wireless emergency alert system communicates with the user devices via a cellular network of a cellular service provider associated with the user devices.

3. The alert system of claim 1, wherein the distribution area is determined based on at least one of a first location of the incident or a second location of the response vehicle.

4. The alert system of claim 1, wherein the one or more processing circuits are configured to:
receive, from a sensor of the response vehicle, sensor data associated with operation of the response vehicle; and
determine the distribution area for the alert based on the sensor data.

5. The alert system of claim 4, wherein the sensor data corresponds to at least one of a speed of the response vehicle or a location of the response vehicle.

6. The alert system of claim 1, wherein:
prior to providing the alert data and the distribution area to the wireless emergency alert system, the one or more processing circuits are configured to receive, from the response vehicle, an activation associated with the alert; and
the one or more processing circuits are configured to provide the alert data and the distribution area to the wireless emergency alert system responsive to receiving the activation.

7. The alert system of claim 6, wherein the activation includes at least one of an operator activating the alert, a speed of the response vehicle exceeding a threshold, or an emergency lights or a siren of the response vehicle being activated.

8. The alert system of claim 1, wherein the one or more processing circuits are configured to:
determine, based on at the alert data, a frequency associated with the alert; and
provide the alert data and the distribution area to the wireless emergency alert system with the frequency such that the wireless emergency alert system distributes the alert to the user devices positioned within the distribution area with the frequency.

9. The alert system of claim 1, wherein:
the distribution area is a first distribution area;
the alert is a first alert; and
the one or more processing circuits are configured to:
determine, based on the alert data, a second distribution area for a second alert; and
provide the alert data and the second distribution area to the wireless emergency alert system such that the wireless emergency alert system distributes the second alert to the user devices positioned withing the second distribution area.

10. The alert system of claim 1, wherein the one or more processing circuits are configured to:
receive an update to the alert data; and
responsive to the update to the alert data resulting in a change to the alert or the distribution area:
determine an updated distribution area for an updated alert; and
provide the alert data and the updated distribution area to the wireless emergency alert system such that the wireless emergency alert system distributes the updated alert to the user devices positioned withing the updated distribution area.

11. A method comprising:
acquiring, from a response vehicle, alert data regarding at least one of an incident or the response vehicle at or responding to the incident;
determining, based on the alert data, a first distribution area for a first alert; and
providing the alert data and the first distribution area to a wireless emergency alert system, wherein the wireless emergency alert system is configured to distribute the first alert including the alert data to user devices positioned within the first distribution area.

12. The method of claim 11, further comprising:
determining, based on the alert data, a second distribution area for a second alert; and
providing the alert data and the second distribution area to the wireless emergency alert system such that the wireless emergency alert system distributes the second alert to the user devices positioned withing the second distribution area.

13. The method of claim 12, wherein:
the first distribution area corresponds to a first area that is affected by the at least one of the incident or the response vehicle;
the second distribution area corresponds to a second area that is predicted to be affected by the at least one of the incident or the response vehicle; and
the second distribution area does not overlap with the first distribution area.

14. The method of claim 11, further comprising:
receiving an update to the alert data;
determining if the update to the alert data results in a change to the first alert or the first distribution area;
responsive to the update to the alert data resulting in a change to the first alert or the first distribution area, determining an updated distribution area for an updated alert; and
providing the alert data and the updated distribution area to the wireless emergency alert system such that the wireless emergency alert system distributes the updated alert to the user devices positioned withing the updated distribution area.

15. The method of claim 14, wherein the update to the alert data includes at least one of a change in a location of the response vehicle, a change in a speed of the response vehicle, or a change in a severity of the incident.

16. An alert system comprising:
a vehicle system configured to be positioned on a vehicle, the vehicle system including a sensor configured to generate sensor data associated with the vehicle; and
one or more processing circuits configured to:
acquire the sensor data;
acquire alert data regarding the vehicle at or responding to an incident;
determine, based on the alert data and the sensor data, a distribution area for an alert; and
provide the alert data and the distribution area to a wireless emergency alert system, wherein the wireless emergency alert system is configured to distribute the alert including the alert data to user devices positioned within the distribution area.

17. The alert system of claim 16, wherein:
the vehicle system includes a user interface configured to receive a user input;
prior to providing the alert data and the distribution area to the wireless emergency alert system, the one or more processing circuits are configured to receive, from the user interface, an activation of the alert based on the user input received by the user interface; and
the one or more processing circuits are configured to provide the alert data and the distribution area to the wireless emergency alert system responsive to receiving the activation.

18. The alert system of claim 16, wherein:
the sensor data corresponds to a location of the vehicle; and
the one or more processing circuits determine the distribution area based on a speed limit associated with the location of the vehicle.

19. The alert system of claim 16, wherein:
the sensor data corresponds to a speed of the vehicle; and
the one or more processing circuits determine the distribution area based on the speed of the vehicle.

20. The alert system of claim 16, wherein:
the vehicle includes emergency lights configured to provide a visual alert and a siren configured to provide an audible alert;
prior to providing the alert data and the distribution area to the wireless emergency alert system, the one or more processing circuits are configured to receive an indication of an activation of at least one of the emergency lights or the siren; and
the one or more processing circuits are configured to provide the alert data and the distribution area to the wireless emergency alert system responsive to receiving the indication.
